(19) United States
(12) Patent Application Publication
(10) Pub. No.: US 2024/0076530 A1
(43) Pub. Date: Mar. 7, 2024

(54) ADHESIVE FILM, OPTICAL MEMBER COMPRISING THE SAME, AND OPTICAL DISPLAY APPARATUS COMPRISING THE SAME

(71) Applicant: SAMSUNG SD1 CO., LTD., Yongin-si (KR)

(72) Inventors: Ji Yeon Kim, Suwon-si (KR); Do Young Kim, Suwon-si (KR); Dong Myeong Shin, Suwon-si (KR); Ji Young Han, Swon-si (KR); Kyoung Gon Park, Suwon-si (KR); Il Jin Kim, Suwon-si (KR)

(21) Appl. No.: 18/454,666

(22) Filed: Aug. 23, 2023

(30) Foreign Application Priority Data
Aug. 23, 2022 (KR) 10-2022-0105795

(51) Int. Cl. C09J 133/10; C09J 11/06

(52) U.S. Cl. CPC C09J 133/10; C09J 11/06; G06F 1/1652

(57) ABSTRACT

An adhesive film, an optical member including the same, and an optical display apparatus including the same are provided. An adhesive film includes a (meth)acrylic based copolymer, a (meth)acrylic based oligomer, and a curing agent and has a maximum shear strain of 50% or less at 60° C. and a peel strength of 600 gf/25 mm or more with respect to a polyimide based film at 25° C.

### CROSS-REFERENCE TO RELATED APPLICATION

The present application claims priority to and the benefit of Korean Patent Application No. 10-2022-0105795, filed on Aug. 23, 2022 in the Korean Intellectual Property Office, the entire disclosure of which is incorporated herein by reference.

### BACKGROUND

### 1. Field

Aspects of embodiments of the present invention relate to an adhesive film, an optical member including the same, and an optical display apparatus including the same.

### 2. Description of the Related Art

In recent years, with rapid increase in interest in foldable optical displays, there is a need for an adhesive film for optical displays, which has good foldability. In addition, since a light emitting diode panel emits heat for a long time in operation of an optical display, a polyimide based film is used as a base film to secure heat resistance and, thus, an adhesive film exhibiting high peel strength with respect to the polyimide based film is desired.

With increasing demand for thickness reduction of optical displays, there is an increasing trend toward reduction in thickness of adhesive films. However, a typical UV-curable adhesive film exhibiting foldability is manufactured using a solvent-free composition in order to improve UV curing efficiency and has a limit in thickness reduction thereof. Further, since the adhesive film is manufactured by curing the composition after deposition of the composition, it is difficult to reduce thickness deviation in manufacture of a thin adhesive film using the solvent-free composition. Although a heat curable adhesive film exhibiting foldability is known in the art, the heat curable adhesive film has a limit in improvement in peel strength to the polyimide based film.

The background technique of the present invention is disclosed in Japanese Unexamined Patent Publication No. 2013-072951 and the like.

### SUMMARY

According to an aspect of one or more embodiments of the present invention, an adhesive film having a thin thickness and a small thickness deviation while exhibiting good foldability is provided.

According to another aspect of one or more embodiments of the present invention, an adhesive film exhibiting good peel strength with respect to a polyimide based film is provided.

According to another aspect of one or more embodiments of the present invention, an adhesive film formed of a heat curable composition and exhibiting good foldability is provided.

In accordance with one or more embodiments of the present invention, an adhesive film is provided.

In one or more embodiments, the adhesive film includes a (meth)acrylic based copolymer, a (meth)acrylic based oligomer, and a curing agent, and has a maximum shear strain of 50% or less at 60° C. and a peel strength of 600 gf/25 mm or more with respect to a polyimide based film at 25° C.

In accordance with one or more embodiments of the present invention, an optical member is provided.

In one or more embodiments, the optical member includes the adhesive film according to an embodiment.

In accordance with one or more embodiments of the present invention, an optical display apparatus is provided.

In one or more embodiments, the optical display apparatus includes the adhesive film according to an embodiment.

One or more embodiments of the present invention provide an adhesive film having a thin thickness and a small thickness deviation while exhibiting good foldability.

Further, one or more embodiments of the present invention provide an adhesive film exhibiting good peel strength with respect to a polyimide based film.

Further, one or more embodiments of the present invention provide an adhesive film formed of a heat curable composition and exhibiting good foldability.

### BRIEF DESCRIPTION OF THE DRAWINGS

FIG. 1 is a graph depicting a measurement result of shear strain of an adhesive film according to an embodiment of the present invention.

FIGS. 2A and 2B are diagrams depicting a method for measuring peel strength of an adhesive film according to an embodiment with respect to a polyimide based film or a polyethylene terephthalate film.

FIGS. 3A and 3B are diagrams depicting a method for measuring peel strength of an adhesive film according to an embodiment with respect to a glass plate.

### DETAILED DESCRIPTION

Herein, some embodiments of the present invention will be described in further detail. However, it is to be understood that the present invention is not limited to the following embodiments and may be embodied in different ways. The following embodiments are provided to provide a thorough understanding of the invention to those skilled in the art.

The terminology used herein is for the purpose of describing example embodiments and is not intended to limit the scope of the invention. Herein, the singular forms “a,” “an,” and “the” are intended to include the plural forms as well, unless the context clearly indicates otherwise.

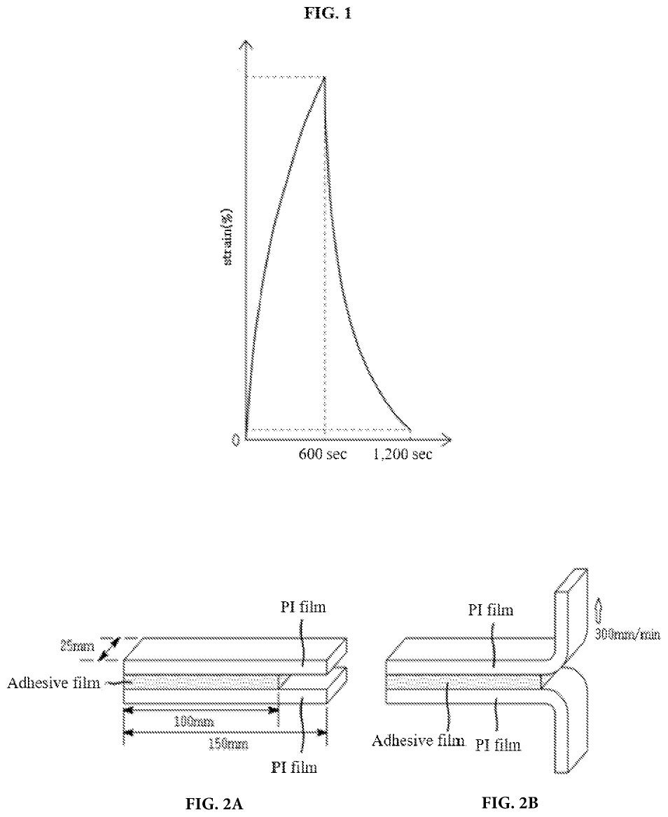

Herein, “shear strain” refers to a value measured at 60° C. and means a degree of deformation of an adhesive film specimen upon application of constant force to the specimen in a shear direction over time. Referring to FIG. 1, shear strain of an adhesive film is measured upon application of constant force to a specimen of the adhesive film over time under experimental conditions described below. Here, the maximum shear strain at 60° C. means a maximum value of shear strain in the graph shown in FIG. 1.

Herein, “(meth)acryl” refers to acryl and/or methacryl.

Herein, “weight average molecular weight” may refer to a value measured by gel permeation chromatography in polystyrene standards.

As used herein to represent a specific numerical range, the expression “X to Y” means a value greater than or equal to X and less than or equal to Y (X≤ and ≤Y).

The present invention provides an adhesive film having a thin thickness and a small thickness deviation while exhibiting good foldability and good peel strength with respect to a polyimide based film. Further, the present invention provides an adhesive film formed of a heat curable composition and exhibiting foldability. As a heat curable optically clear adhesive (OCA), the adhesive film according to the invention may be used in a foldable optical display apparatus.

In an embodiment, the adhesive film may have a thickness of 20 μm or less. Within this range, the adhesive film can achieve sufficient reduction in thickness when used in a foldable optical display apparatus by providing an ultra-thin thickness. In an embodiment, the adhesive film may have a thickness of greater than 0 μm to 20 μm, or 5 μm to 15 μm.

In an embodiment, the adhesive film has a peel strength of 600 gf/25 mm or more at 25° C. with respect to a polyimide based film. Within this range, the adhesive film can be adhered to a polyimide based film of a foldable optical display apparatus with high reliability. For example, the adhesive film may have a peel strength of 600, 650, 700, 750, 800, 850, 900, 950, 1,000, 1,050, 1,100, 1,150, 1,200, 1,250, 1,300, 1,350, 1,400, 1,450, 1,500, 1,550, 1,600, 1,650, 1,700, 1,750, 1,800, 1,850, 1,900, 1,950, or 2,000 gf/25 mm, or in a range of 600 gf/25 mm to 2,000 gf/25 mm, as measured by a peeling test at a peeling angle of 180°. Here, “high reliability” means that, when the adhesive film is applied to a foldable optical display apparatus, the adhesive film secures foldability of the foldable optical display apparatus without being peeled off of a polyimide based film at room temperature (for example: 25° C.), at high temperature (for example: 60° C.), at high temperature and high humidity (for example: 60° C. and 95% RH), and at low temperature (for example: −20° C.).

In an embodiment, the adhesive film may have a peel strength of 400 gf/25 mm or more at 85° C. with respect to the polyimide based film. Within this range, the adhesive film can be adhered to the polyimide based film of the foldable optical display apparatus with high reliability. For example, the adhesive film may have a peel strength of 400, 450, 500, 550, 600, 650, 700, 750, 800, 850, 900, 950, 1,000, 1,050, 1,100, 1,150, 1,200, 1,250, 1,300, 1,350, 1,400, 1,450, or 1,500 gf/25 mm, or in a range of 400 gf/25 mm to 1,500 gf/25 mm, as measured by a peeling test at a peeling angle of 1800.

The adhesive film may have high peel strength at both 25° C. and 85° C. with respect to the polyimide based film and a low ratio of peel strength at 85° C. to peel strength at 25° C. with respect to the polyimide based film, thereby securing high reliability when applied to optical display apparatuses. In an embodiment, the adhesive film may have a peel strength ratio of 0.55 or more, for example, 0.58 to 1, with respect to the polyimide based film, in which the peel strength ratio refers to the ratio of peel strength at 85° C. to peel strength at 25° C.

Since the polyimide based film has better flexibility and heat resistance than other polymer films, the polyimide based film is generally used as a base film of a window film in a foldable optical display apparatus or as a base film of an optical display panel, such as an OLED panel and the like. The polyimide based film may be a film manufactured by a typical method known to those skilled in the art. For example, the polyimide based film may be a film formed by reaction between a dianhydride and a diamine. The dianhydride may include any of pyromellitic dianhydride, benzoquinone tetracarboxylic dianhydride, naphthalene tetracarboxylic dianhydride, and the like, and the diamine may include any of oxydianiline, phenylene diamine, diaminodiphenyl methane, and the like.

In an embodiment, the adhesive film may have a maximum shear strain of 50% or less at 60° C. and a thickness deviation of 4 nm or less. Within this range, the adhesive film can minimize or reduce degradation of screen quality due to an uneven thickness thereof when applied to a foldable optical display apparatus under a wide range of conditions. Here, the wide range of conditions may include room temperature (for example: 25° C.), high temperature (for example: 60° C.), high temperature and high humidity (for example: 60° C. and 95% RH), and low temperature (for example: −20° C.). In an embodiment, the adhesive film may have a maximum shear strain of 1% to 50% at 60° C., and, in an embodiment, 10% to 40%. In an embodiment, the adhesive film may have a thickness deviation of 0 nm to 4 nm.

In an embodiment, the adhesive film may have a storage modulus at −20° C. of 0.2 MPa or less, for example, 0.001 MPa to 0.2 MPa, and, in an embodiment, 0.05 MPa to 0.2 MPa, for example, 0.05, 0.06, 0.07, 0.08, 0.09, 0.1, 0.11, 0.12, 0.13, 0.14, 0.15, 0.16, 0.17, 0.18, 0.19, or 0.2 MPa. Within this range, the adhesive film can secure good foldability under a wide range of conditions.

In an embodiment, the adhesive film may have a storage modulus at 25° C. of 0.2 MPa or less, for example, 0.001 MPa to 0.2 MPa, and, in an embodiment, 0.1 to 0.2 MPa. Within this range, the adhesive film can secure good foldability under a wide range of conditions.

In an embodiment, the adhesive film may have a storage modulus at 60° C. of 0.2 MPa or less, for example, 0.001 MPa to 0.2 MPa, and, in an embodiment, 0.01 MPa to 0.1 MPa, for example, 0.01, 0.02, 0.03, 0.04, 0.05, 0.06, 0.07, 0.08, 0.09, or 0.1 MPa. Within this range, the adhesive film can secure good foldability under a wide range of conditions.

In an embodiment, the adhesive film may have a storage modulus ratio (storage modulus at −20° C.:storage modulus at 60° C.) of 1:0.1 to 1:0.8, and, in an embodiment, 1:0.1, 1:0.2, 1:0.3, 1:0.4, 1:0.5, 1:0.6, 1:0.7, or 1:0.8, for example, 1:0.2 to 1:0.5. Within this range, the adhesive film can secure good foldability under a wide range of conditions.

In an embodiment, the adhesive film may have a tan δ peak temperature of 0° C. or less, and, in an embodiment, −50° C. to 0° C., for example, −50° C., −45° C., −40° C., −35° C., −30° C., −25° C., −20° C., −15° C., −10° C., −5° C., or 0° C., and, in an embodiment, −50° C. to −15° C. Within this range, the adhesive film can assist in providing good foldability under a wide range of conditions.

In an embodiment, the adhesive film may have a haze of 1% or less, for example, 0% to 1%, in the visible spectrum, for example, at a wavelength of 380 nm to 780 nm. Within this range, the adhesive film can be used in an optical display apparatus.

In an embodiment, the adhesive film may have a peel strength of 600 gf/25 mm or more at 25° C. with respect to a glass plate. Within this range, the adhesive film can be adhered to various optical elements of a foldable optical display apparatus with high reliability. For example, the adhesive film may have a peel strength of 600, 650, 700, 750, 800, 850, 900, 950, or 1,000 gf/25 mm, for example, 600 gf/25 mm to 1,000 gf/25 mm, as measured by a peeling test at a peeling angle of 90°.

In an embodiment, the adhesive film may have a peel strength of 600 gf/25 mm or more at 25° C. with respect to a polyethylene terephthalate film subjected to corona treatment. Within this range, the adhesive film can be adhered to various optical elements of a foldable optical display apparatus with high reliability. For example, the adhesive film may have a peel strength of 600, 650, 700, 750, 800, 850, 900, 950, or 1,000 gf/25 mm, for example, 600 gf/25 mm to 1,000 gf/25 mm, as measured by a peeling test at a peeling angle of 180°.

In an embodiment, the adhesive film may have a peel strength of 400 gf/25 mm or more at 85° C. with respect to the polyethylene terephthalate film subjected to corona treatment. Within this range, the adhesive film can be adhered to various optical elements of a foldable optical display apparatus with high reliability. For example, the adhesive film may have a peel strength of 400, 450, 500, 550, 600, 650, 700, 750, 800, 850, 900, 950, 1,000 gf/25 mm, for example, 400 gf/25 mm to 1,000 gf/25 mm, as measured by a peeling test at a peeling angle of 180°.

The adhesive film includes a (meth)acrylic based copolymer, a (meth)acrylic based oligomer, and a curing agent. The curing agent may be an isocyanate curing agent. The adhesive film may further include a metal chelate based curing agent. The adhesive film may further include a silane coupling agent.

In an embodiment, the adhesive film may be formed of a composition including a (meth)acrylic based copolymer, a (meth)acrylic based oligomer, and a curing agent. The curing agent may be a tri- or higher functional isocyanate based curing agent. The composition may further include a metal chelate based curing agent. The composition may further include a silane coupling agent. In an embodiment, the adhesive film may include a heat-cured product of the composition. In an embodiment, the adhesive film may comprise a heat-cured product of the composition. 1 [0045] The (meth)acrylic based copolymer may form a matrix of the adhesive film through reaction with the (meth)acrylic based oligomer and the curing agent described below and may assist in providing peel strength and shear strain.

The (meth)acrylic based copolymer may be a copolymer of a monomer mixture including alkyl group-containing (meth)acrylic based monomers.

The alkyl group-containing (meth)acrylic based monomer may be selected from among C₁ to C₂₀ linear or branched alkyl group-containing (meth)acrylic based monomers. The C₁ to C₂₀ linear or branched alkyl group-containing (meth)acrylic based monomers may be (meth)acrylic esters each having a C₁ to C₂₀ alkyl group at an ester site thereof and may include at least one selected from among, for example, methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, heptyl (meth)acrylate, 2-ethylhexyl (meth)acrylate, heptyl (meth)acrylate, octyl (meth)acrylate, iso-octyl (meth)acrylate, nonyl (meth)acrylate, decyl (meth)acrylate, and dodecyl (meth)acrylate.

In an embodiment, in the monomer mixture, the alkyl group-containing (meth)acrylic based monomer may be present in an amount of 90 wt % or more, and, in an embodiment, 95 wt % to 100 wt %, and, in an embodiment, 99 wt % to 100 wt %. Within this range, the composition can easily form a matrix of the adhesive film.

The (meth)acrylic based copolymer may be a copolymer of the monomer mixture including a (meth)acrylic based monomer having a homopolymer glass transition temperature of −50° C. or less. The (meth)acrylic based monomer having a homopolymer glass transition temperature of −50° C. or less can assist in achievement of shear strain and peel strength of the adhesive film by reducing the glass transition temperature of the (meth)acrylic based copolymer. In an embodiment, the (meth)acrylic based monomer may have a homopolymer glass transition temperature of −80° C. to −50° C. The homopolymer glass transition temperature of the (meth)acrylic based monomer may be measured by a typical method known to those skilled in the art or obtained from a commercially available catalogue.

In an embodiment, the (meth)acrylic based monomer having a homopolymer glass transition temperature of −50° C. or less may be present in an amount of 90 wt % or more, and, in an embodiment, 95 wt % to 100 wt %, and, in an embodiment, 99 wt % to 100 wt %, in the monomer mixture. Within this range, the (meth)acrylic based monomer can easily reduce the glass transition temperature of the (meth)acrylic based copolymer.

The (meth)acrylic based monomer having a homopolymer glass transition temperature of −50° C. or less may be the alkyl group-containing (meth)acrylic based monomer, and the monomer mixture may contain at least one, and, in an embodiment, at least two (meth)acrylic based monomers having a homopolymer glass transition temperature of −50° C. or less.

In an embodiment, the alkyl group-containing (meth)acrylic based monomer may be a mixture of a first monomer having a homopolymer glass transition temperature of −50° C. or less and a second monomer having a homopolymer glass transition temperature of −50° C. or less. The first monomer has a different homopolymer glass transition temperature, and, in an embodiment, a lower homopolymer glass transition temperature, than the second monomer. When the total mole number of the first monomer and the second monomer is 100, a mole ratio of the first monomer to the second monomer in the mixture (a mole of the first monomer: a mole of the second monomer) may be in a range from 40:60 to 70:30. Within this range, the alkyl group-containing (meth)acrylic based monomer can easily reduce the glass transition temperature of the (meth)acrylic based copolymer. For example, the first monomer may be n-butyl acrylate or the like. The second monomer may be 2-ethylhexyl acrylate or the like.

The monomer mixture may contain a trace amount of at least one (meth)acrylic based monomer containing a crosslinking functional group or may be free from at least one (meth)acrylic based monomer containing a crosslinking functional group. However, the monomer mixture may further include at least one (meth)acrylic based monomer containing a crosslinking functional group so long as the effects of the present invention are not affected thereby. In an embodiment, the (meth)acrylic based monomer containing a crosslinking functional group may be present in an amount of 1 wt % or less, for example, 0, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, 0.9 wt %, 0.95 wt %, 1 wt %, 0 wt % to 1 wt %, greater than 0 wt % to 0.5 wt %, or greater than 0 wt % to 0.05 wt %, in the monomer mixture.

The (meth)acrylic based monomer containing a crosslinking functional group may include at least one selected from among a hydroxyl group-containing (meth)acrylic based monomer, a carboxylic acid group-containing (meth)acrylic based monomer, an amino group-containing (meth)acrylic based monomer, and an amide group-containing (meth)acrylic based monomer.

The hydroxyl group-containing (meth)acrylic based monomer may be selected from among a (meth)acrylic based monomer containing a C₁ to C₂₀ linear or branched alkyl group having at least one hydroxyl group. For example, the hydroxyl group-containing (meth)acrylic based monomer is a (meth)acrylic based monomer containing a C₁ to C₂₀ alkyl group having at least one hydroxyl group at an ester site and may include at least one selected from among 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 1,4-cyclohexanedimethanol mono(meth)acrylate, 1-chloro-2-hydroxypropyl (meth)acrylate, diethylene glycol mono(meth)acrylate, 2-hydroxy-3-phenyloxypropyl (meth)acrylate, 4-hydroxycyclopentyl (meth)acrylate, and 4-hydroxycyclohexyl (meth)acrylate.

The carboxylic acid group-containing (meth)acrylic based monomer may include (meth)acrylic acid and the like.

The amino group-containing (meth)acrylic based monomer may include alkyl amino (meth)acrylate, dialkylamino (meth)acrylate, and the like.

The amide group-containing (meth)acrylic based monomer may include an alkyl group-containing (meth)acryl amide, such as (meth)acryl amide, dimethyl (meth)acryl amide, and the like.

The (meth)acrylic based copolymer may be a random, block, or alternate copolymer, and, in an embodiment, a random (meth)acrylic based copolymer.

In an embodiment, the (meth)acrylic based copolymer may have a glass transition temperature of −50° C. or less, for example, −70° C., −65° C., −60° C., −55° C., or −50° C., and, in an embodiment, −70° C. to −50° C. Within this range, the adhesive film can easily reach the shear strain and peel strength according to the present invention.

In an embodiment, the (meth)acrylic based copolymer may have a weight average molecular weight of 800,000 g/mol or more, for example, 800,000, 900,000, 1,000,000, 1,100,000, 1,200,000, 1,300,000, 1,400,000, or 1,500,000 g/mol, and, in an embodiment, 800,000 g/mol to 1,500,000 g/mol, and, in an embodiment, 1,000,000 g/mol to 1,300,000 g/mol. Within this range, the adhesive film can easily reach shear strain and peel strength according to the present invention. Here, “weight average molecular weight” may be obtained by gel permeation chromatography in polystyrene standards.

In an embodiment, the (meth)acrylic based copolymer may have a polydispersity index (PDI) of 3 to 10, for example, 3 to 5. Within this range, the effects of the present invention can be easily realized.

In an embodiment, the (meth)acrylic based copolymer may have an acid value of 0.5 mgKOH/g or less, and, in an embodiment, 0 mgKOH/g to 0.5 mgKOH/g, and, in an embodiment, 0 mgKOH/g. Within this range, the (meth)acrylic based copolymer can suppress corrosion upon contact between the adhesive film and a metal-containing optical element.

The (meth)acrylic based copolymer may be prepared through polymerization of the monomer mixture by a typical polymerization method. The typical polymerization method may include a typical method known to those skilled in the art. For example, the (meth)acrylic based copolymer may be prepared by adding an initiator to the monomer mixture, followed by polymerization of the monomer mixture by a typical polymerization method, for example, suspension polymerization, emulsion polymerization, solution polymerization, and the like. In an embodiment, polymerization may be performed at a temperature of 60° C. to 70° C. for 6 hours to 8 hours. The initiator may be a typical initiator including azo-based polymerization initiators and/or peroxides, such as benzoyl hydroxide or acetyl hydroxide.

The (meth)acrylic based oligomer serves to provide the shear strain according to the present invention while improving peel strength of the adhesive film with respect to the polyimide based film.

The (meth)acrylic based oligomer may have a higher glass transition temperature than the (meth)acrylic based copolymer and may allow the adhesive film to have a suitable storage modulus at room temperature.

In an embodiment, the (meth)acrylic based oligomer may have a glass transition temperature of 60° C. or less, for example, less than 60° C., and, in an embodiment, 20° C. to 60° C., for example, 30° C. to 50° C., for example, 30° C. to 40° C. Within this range, the (meth)acrylic based oligomer can assist in reduction in storage modulus at low temperature while improving peel strength of the adhesive film with respect to the polyimide based film. 1 [0068] The (meth)acrylic based oligomer may have a lower weight average molecular weight than the (meth)acrylic based copolymer. For example, the (meth)acrylic based oligomer may have a weight average molecular weight of 3,000 g/mol to 50,000 g/mol, for example, 10,000 g/mol to 40,000 g/mol. Within this range, the (meth)acrylic based oligomer can assist in reduction in storage modulus at low temperature while improving peel strength of the adhesive film with respect to the polyimide based film.

The (meth)acrylic based oligomer may have a hydroxyl group as a crosslinking functional group. As a result, the (meth)acrylic based oligomer can improve reaction of the curing agent and peel strength even with a (meth)acrylic based copolymer having a low content of the crosslinking functional group. The hydroxyl group may be provided by a (meth)acrylic based monomer having the hydroxyl group described above in preparation of the (meth)acrylic based oligomer.

In an embodiment, the (meth)acrylic based oligomer may include a (meth)acrylic based monomer having a homopolymer glass transition temperature of 90° C. or more, for example, 100° C. to 120° C., as a main component. Within this range, the adhesive film can prevent or substantially prevent excessive increase in storage modulus at high temperature and can secure the above range of glass transition temperature. For example, the (meth)acrylic based monomer may be a monofunctional (meth)acrylic based monomer, and, in an embodiment, at least one selected from among methyl methacrylate, methacrylic acid, and t-butyl methacrylate, without being limited thereto. Here, “main component” means that the corresponding monomer is present in an amount of about 50 wt % or more, or 60 wt % or more, in the total units of the (meth)acrylic based oligomer.

In an embodiment, the (meth)acrylic based oligomer may further include a (meth)acrylic based monomer having a homopolymer glass transition temperature of 50° C. or less, for example, −60° C. to 0° C. For example, the (meth)acrylic based monomer having a homopolymer glass transition temperature of 50° C. or less may include n-butyl acrylate and the like.

The (meth)acrylic based oligomer may be prepared through polymerization of the monomer mixture by a typical polymerization method. The typical polymerization method may include a typical method known to those skilled in the art. For example, the (meth)acrylic based oligomer may be prepared by adding an initiator to the monomer mixture, followed by polymerization of the monomer mixture by a typical polymerization method, for example, suspension polymerization, emulsion polymerization, solution polymerization, and the like. Here, the polymerization temperature and time may be adjusted within the range providing the weight average molecular weight and the glass transition temperature within the above ranges. The initiator may be a typical initiator including azo-based polymerization initiators and/or peroxides, such as benzoyl hydroxide or acetyl hydroxide.

In an embodiment, the (meth)acrylic based oligomer may be present in an amount of 5 parts by weight or less, for example, greater than 0 parts by weight to 5 parts by weight, 0.001 parts by weight to 0.1 parts by weight, or 0.01 parts by weight to 0.1 parts by weight, relative to 100 parts by weight of the (meth)acrylic based copolymer. Within this range, the (meth)acrylic based oligomer can provide the shear strain according to the present invention while improving peel strength of the adhesive film with respect to the polyimide based film.

The curing agent may assist in reduction in shear strain of the adhesive film by improving peel strength of the adhesive film and the degree of crosslinking of the adhesive film.

In an embodiment, the curing agent may be a tri- or higher functional isocyanate based curing agent. The tri- or higher functional isocyanate based curing agent can significantly reduce the shear strain of the adhesive film by improving peel strength and the crosslinking degree of the adhesive film, as compared to a bifunctional isocyanate based curing agent.

As the tri- or higher functional isocyanate based curing agent, a curing agent having three or more isocyanate groups (NCO) may be used without limitation. In an embodiment, the curing agent may include: adducts or burets of isocyanate based compounds with polyol compounds such as trimethylolpropane and the like, such as a trifunctional isocyanurate. The isocyanate based compounds may include aromatic diisocyanates, such as 2,4-toluene diisocyanate (2,4-TDI), 2,6-toluene diisocyanate (2,6-TDI), 4,4′-diphenylmethane diisocyanate (4,4′-MDI), 2,4′-diphenylmethanediisocyanate (2,4′-MDI), 1,4-phenylene diisocyanate, xylylene diisocyanate (XDI), tetramethylxylene diisocyanate (TMXDI), toluidine diisocyanate (TODI), 1,5-naphthalene diisocyanate (NDI), and the like; aliphatic diisocyanates, such as hexamethylene diisocyanate (HDI), trimethylhexamethylene diisocyanate (TMHDI), lysine diisocyanate, norbornene diisocyanate (NBDI), and the like; alicyclic diisocyanates, such as trans-cyclohexane-1,4-diisocyanate, isophorone diisocyanate (IPDI), H6-XDI (hydrogenated XDI), H12-MDI (hydrogenated MDI), and the like; carbodiimide-modified diisocyanates of the diisocyanates, and the like. For example, the tri- or higher functional isocyanate based curing agent may be a trifunctional isocyanate adduct between toluene diisocyanate and trimethylolpropane.

In an embodiment, the curing agent, for example, the tri- or higher functional isocyanate based curing agent, may be present in an amount of 1 part by weight or less, for example, greater than 0 to 1 part by weight or less, 0.001 parts by weight to 1 part by weight, 0.001 parts by weight to 0.5 parts by weight, or 0.001 parts by weight to 0.1 parts by weight, relative to 100 parts by weight of the (meth)acrylic based copolymer. Within this range, the curing agent can easily secure the shear strain and peel strength of the adhesive film according to the invention. 1 [0078] The composition may further include a metal chelate based curing agent as a curing agent.

The metal chelate based curing agent may act as a curing catalyst and may increase the curing rate upon heat curing of the composition.

The metal chelate based curing agent is a curing agent composed of metal-chelate bonds and may include a typical curing agent known to those skilled in the art. In an embodiment, the metal chelate based curing agent may include a curing agent having two or more, for example, 3 to 6, metal-chelate bonds. For example, the metal may include any of aluminum, zirconium, titanium, and cobalt, and, in an embodiment, aluminum. For example, the chelate may include any of acetylacetonate, ethylacetoacetate, and the like, without being limited thereto. In an embodiment, the metal chelate based curing agent may include at least one selected from among acetylacetonate aluminate, aluminum tris(acetylacetonate), aluminum tris(ethylacetoacetate), aluminum bis(acetoacetate), zirconium tris(acetylacetonate), and cobalt tris(acetylacetonate), without being limited thereto.

In an embodiment, the metal chelate based curing agent may be present in an amount of 5 parts by weight or less, for example, 0 parts by weight to 5 parts by weight or less, greater than 0 parts by weight to 5 parts by weight or less, 0.001 parts by weight to 5 parts by weight, 0.001 parts by weight to 1 part by weight, or 0.001 parts by weight to 1 part by weight, relative to 100 parts by weight of the (meth)acrylic based copolymer. Within this range, the metal chelate based curing agent can improve the heat curing rate of the adhesive film.

The composition, that is, the adhesive film, may further include a silane coupling agent.

The silane coupling agent may further improve peel strength of the adhesive film. The silane coupling agent may include any typical silane coupling agent known to those skilled in in the art. For example, the silane coupling agent may include an epoxy group-containing silane coupling agent, such as glycidoxypropyltrimethoxysilane, glycidoxypropylmethyldimethoxysilane, and the like, without being limited thereto.

In an embodiment, the silane coupling agent may be present in an amount of 0.01 parts by weight to 5 parts by weight, relative to 100 parts by weight of the (meth)acrylic based copolymer. Within this range, the silane coupling agent can improve peel strength of the adhesive film.

The composition may further include a solvent. The solvent serves to make the surface of the adhesive film uniform or substantially uniform upon fabrication of the adhesive film having a thin thickness, and, in an embodiment, a thickness of 20 μm or less, using the composition. The solvent may be a typical solvent known to those skilled in the art, without being limited thereto. For example, the solvent is an organic solvent, such as ethyl acetate, methyl ethyl ketone, or methyl isobutyl ketone, without being limited thereto. In an embodiment, the composition may have a solid content of 50 wt % or less, for example, 20 wt % or less.

The composition, that is, the adhesive film, may further include an additive. The additive may provide an additional function to the adhesive film. For example, the additive may include at least one selected from among UV absorbers, reaction inhibitors, adhesion enhancers, thixotropic modifiers, conductive modifiers, color modifiers, stabilizers, antioxidants, leveling agents, and antistatic agents, without being limited thereto. The content of the additives in the composition, that is, in the adhesive film, may be suitably selected so as not to affect the effects of the present invention.

The adhesive film may be manufactured by heat curing the composition, and, in an embodiment, the composition containing the solvent. For example, the adhesive film may be manufactured by coating the composition to a thickness (e.g., a predetermined thickness) on a release film and forming a coat by drying the composition to remove the solvent from the composition, followed by heat treatment of the coat under heat curing conditions. Here, the heat curing conditions may mean that the coat is heat treated at 90° C. to 120° C. for 1 minute to 1 hour.

Next, an optical member according to an embodiment of the invention will be described.

The optical member includes an optical film and an adhesive film formed on at least one surface of the optical film, wherein the adhesive film includes the adhesive film according to an embodiment of the present invention. Accordingly, the optical member exhibits good bending/folding properties to be used in a flexible display apparatus.

In some embodiments, the optical film provides optical functions, for example, polarization, optical compensation, display quality improvement, and/or conductivity, to a display apparatus. Examples of the optical film may include a window film, a window, a polarizing plate, a color filter, a retardation film, an elliptical polarizing film, a reflective polarizing film, an anti-reflection film, a compensation film, a brightness enhancing film, an alignment film, a light diffusion film, a glass shatterproof film, a surface protective film, an OLED device barrier layer, a plastic LCD substrate, and a transparent electrode film including indium tin oxide (ITO), fluorinated tin oxide (FTO), aluminum-doped zinc oxide (AZO), carbon nanotubes (CNT), Ag nanowires, graphene, or the like. These optical films may be easily manufactured by those skilled in the art.

For example, a touch panel may be formed by attaching a window or an optical film to a touchpad via the adhesive film. As another example, the adhesive film may be applied to a typical polarizing film as in the art.

In other embodiments, the optical film is an optically transparent film and the optical member including the optical film and the adhesive film may act as a support layer for display elements. For example, the display elements may include a window film and the like. The window film may include the optical member and a window coating layer (for example: silicone coating layer) formed on the optical member. In an embodiment, the optical film may have a total light transmittance of 90% or more in the visible spectrum and may be formed of at least one resin selected from among cellulose based resins including triacetylcellulose and the like, polyester based resins including polyethylene terephthalate, polyethylene naphthalate, polybutylene terephthalate, polybutylene naphthalate, and the like, polycarbonate based resins, polyimide based resins, polystyrene based resins, polyacrylate based resins including poly(methyl methacrylate) and the like, cyclic olefin polymer based resins, acryl based resins, and polyamide based resins. In an embodiment, the optical film may have a thickness of 10 μm to 100 μm, and, in an embodiment, 20 μm to 75 μm, and, in an embodiment, 30 μm to 50 μm. Within this range, the optical film can be used as the support layer of the display element.

The optical member may have a bilayer structure including an optical film and the adhesive film formed on a surface of the optical film. In another embodiment, the optical member may be a film laminate including two or more optical films, which are stacked via the adhesive film according to the present invention.

An optical display apparatus according to the present invention includes the adhesive film according to the present invention.

The optical display apparatus may include, for example, a light emitting diode display, such as an organic light emitting diode display and the like, a liquid crystal display, and the like. The optical display apparatus may include a flexible display. In other embodiments, the optical display apparatus may include a non-flexible display.

Next, the present invention will be described in further detail with reference to some examples. However, it is to be understood that these examples are provided for illustration and should not be construed in any way as limiting the invention.

### Example 1

A (meth)acrylic based binder was prepared through polymerization of 100 parts by weight of a monomer mixture including 50 parts by weight of an n-butyl acrylate (n-BA), 49 parts by weight of 2-ethylhexyl acrylate (2-EHA), and 1 part by weight of 4-hydroxybutyl acrylate (4-HBA).

A composition having a sold content of 20 wt % was prepared by mixing 100 parts by weight of the (meth)acrylic based binder, 0.08 parts by weight of (meth)acrylic based oligomer 1, 0.03 parts by weight of a tri-functional isocyanate based curing agent, 0.05 parts by weight of a metal chelate based curing agent, and 0.05 parts by weight of a silane coupling agent in terms of solid content, and adding an organic solvent (ethyl acetate) to the mixture.

The composition was coated to a predetermined thickness on a first PET release film (lightweight thin release film) and dried to form a coat having a post-drying thickness of 15 μm, and the coat was covered by a second PET release film (medium thin release film) and dried at 100° C. for 3 minutes, thereby preparing an adhesive sheet including a 15 μm thick adhesive film between the first PET release film and the second PET release film.

### Examples 2 and 3

Adhesive films were prepared in the same manner as in Example 1 except that the (meth)acrylic based binder and the (meth)acrylic based oligomer were changed together with the content of each component of the composition, as listed in Table 1. In Table 1, each component was represented in parts by weight and represents that the corresponding component is not present.

### Comparative Examples 1 to 5

Adhesive films were prepared in the same manner as in Example 1 except that the (meth)acrylic based binder and the (meth)acrylic based oligomer were changed together with the content of each component of the composition, as listed in Table 1.

### Comparative Example 6

In a reactor, 100 parts by weight of a monomer mixture including 20 parts by weight of 4-hydroxybutyl acrylate (4-HBA) and 80 parts by weight of 2-ethylhexyl acrylate (2-EHA) was sufficiently mixed with 0.03 parts by weight of an initiator (Irgacure 651, 2,2-dimethoxy-2-phenylacetophenone, BASF). After replacing dissolved oxygen in the reactor with nitrogen gas, the mixture was partially polymerized by irradiation of the mixture with UV light under a low-pressure mercury lamp, thereby preparing a viscous liquid having a viscosity of 5,000 cP at 25° C. 0.5 parts by weight of an initiator (Irgacure 184, 1-hydroxycyclohexylphenylketone, BASF) was added to and mixed with the viscous liquid, thereby preparing a solvent-free adhesive composition. The adhesive composition was deposited onto a PET (polyethylene terephthalate) release film and irradiated with UV light at a dose of 2,000 mJ/cm², thereby preparing an adhesive sheet of the adhesive film (thickness: 15 μm) and the PET film.

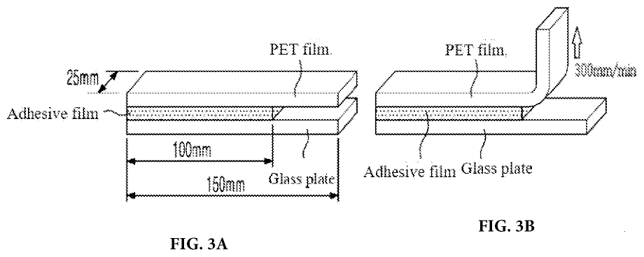

Table 1 shows components of the adhesive films of the Examples and Comparative Examples. The adhesive films of the Examples and Comparative Examples were evaluated as to properties shown in Table 1.
(1) Thickness deviation of adhesive film (unit: nm): A thickness (thickness 1) of each of the adhesive sheets prepared in the Examples and Comparative Examples and each including the 15 μm thick adhesive film between the first PET release film and the second PET release film was measured in an in-plane direction using a thickness meter (Mitutoyo Corp. ID-C112X). Thereafter, a thickness (thickness 2) of the first PET release film and a thickness (thickness 3) of the second PET release film were measured. The maximum value and the minimum value were obtained by calculating an equation: thickness 1−thickness 2−thickness 3, and a value obtained by subtracting the minimum value from the maximum value was defined as the thickness deviation.
(2) Peel strength with respect to polyimide based film (unit: gf/25 mm): Each of the adhesive sheets prepared in the Examples and Comparative Examples was cut to a size of 100 mm×25 mm (length×width), and the first PET release film was removed from the adhesive sheet and the adhesive film was adhered to a polyimide based film (GL200A, SKC Kolong, 150 mm×25 mm×50 μm (length×width×thickness), followed by removal of the second PET release film. Thereafter, the adhesive film was adhered to another polyimide based film (GL200A, SKC Kolong, 150 mm×25 mm×50 μm (length×width×thickness) and pressed using a 2 kg hand roller, thereby preparing a specimen including the polyimide based film, the adhesive film, and the polyimide based film sequentially stacked in the stated order, as shown in FIG. 2A. The prepared specimen was autoclaved at a pressure of 3.5 bar and at 50° C. for 1,000 seconds and secured to a peel strength tester (TA.XT-Plus Texture Analyzer, Stable Micro System). With one polyimide based film secured to the peel strength tester, T-peel strength, at which the adhesive film was peeled off of the other polyimide based film, was measured upon peeling the other polyimide based film from the adhesive film using a TA.XT-Plus Texture Analyzer under conditions of a peeling angle of 180° and a peeling speed of 300 mm/min at 25° C. or 85° C., as shown in FIG. 2B.
(3) Peel strength with respect to polyethylene terephthalate (PET) film (unit: gf/25 mm): A specimen including a PET release film, an adhesive film, and a corona-treated PET release film sequentially stacked in the stated order was prepared using a PET release film subjected to corona treatment (conditions: corona treatment twice at 78 doses for each time (total dose: 156 doses)) instead of the polyimide based film in (2). Peel strength was measured on the specimen in the same manner as in (2) upon peeling the corona-treated PET release film from the adhesive film under conditions of a peeling angle of 180° and a peeling speed of 300 mm/min at 25° C. or 85° C.
(4) Peel strength with respect to glass plate (unit: gf/25 mm): A specimen including a glass plate, an adhesive film, and a corona-treated PET release film sequentially stacked in the stated order as shown in FIG. 3A was prepared using a glass plate (soda lime glass plate) instead of the polyimide based film. Peel strength was measured on the specimen upon peeling the adhesive film from the glass plate at a peeling angle of 90°, a peeling speed of 300 mm/min and 25° C. by a method shown in FIG. 3B.
(5) Shear strain (unit: %): An adhesive film (length×width×thickness: 100 mm×25 mm×15 μm) was obtained by removing the PET films from both sides of the adhesive sheet prepared in each of the Examples and Comparative Examples. Plural adhesive films were stacked to form a stack, which in turn was punched using a $8 mm punching machine, thereby preparing a cylindrical specimen (thickness: 400 μm, diameter: 8 mm) having upper and lower surfaces.

The cylindrical specimen was mounted on a rheometer (DHR3, TA Instrument Inc.) as a dynamic viscoelasticity instrument such that the upper and lower surfaces of the specimen were secured to upper and lower jigs thereof, respectively. Strain at 600 sec stress was measured as the maximum strain by applying force for 600 sec (600 sec stress) and then releasing the force for 600 sec (600 sec release) under conditions of a chamber temperature of 60° C., an axial force of 1 N and a torque of 2,000 Pa, and was set to shear strain. By measuring the shear strain, strains according to time could be obtained as shown in FIG. 1. In FIG. 1, the X-axis indicates time (unit:sec) and the Y-axis indicates strain (unit: %).
(6) Storage modulus (unit:MPa): With the release films removed from both sides of the adhesive sheet prepared in each of the Examples and Comparative Examples, plural adhesive films were stacked to prepare a sample having a thickness of 500 μm. A specimen was prepared by punching the sample using a $8 mm punching machine. Then, storage modulus was measured on the specimen in a temperature sweep test mode under conditions of 1% strain and 1 Hz using a rheometer (DHR3, TA Instrument Inc.) as a dynamic viscoelasticity instrument while increasing temperature from −50° C. to 100° C. at a rate of 5° C./min. Storage modulus was measured at −20° C. and at 60° C.
(7) tan δ peak temperature (unit: ° C., tan δ MAX): Storage modulus and loss modulus were measured as in (6). Then, the temperature at which tan δ, defined as the ratio of loss modulus to storage modulus, becomes the maximum value was measured.
(8) Foldability at low temperature: An adhesive film was obtained by removing the release films from both sides of the adhesive sheet prepared in each of the Examples and Comparative Examples. With the adhesive film interposed between 50 μm thick polyethylene terephthalate (PET) films subjected to corona treatment, the corona treated surfaces of the PET films were adhered to the adhesive film using a roller, followed by aging at room temperature for 12 hours and cutting the stack to a size of 140 mm×70 mm (length×width) to prepare a specimen. The specimen was secured to a flexibility testing machine (CFT-200, Covotech Co., Ltd.) via adhesives (4965, Tesa Co., Ltd.) and subjected to a bending test at −20° C. and at a rate of 30 cycles per minute, where 1 cycle refers to an operation of folding and unfolding the specimen once in the longitudinal direction of the specimen (140 mm length) such that a bent portion of the specimen had a radius of curvature of 3 mm. The number of cycles at which cracks were initially generated on the polyethylene terephthalate film was measured while repeating the bending test. A greater number of cycles indicates easier relaxation of stress applied to the polyethylene terephthalate film in the bending test. 100,000 or more cycles were rated as OK and less than 100,000 cycles were rated as NG.

TABLE 1

| | | | Example | | | Comparative Example | | | | | |
|---|---|---|---|---|---|---|---|---|---|---|---|
| | | | 1 | 2 | 3 | 1 | 2 | 3 | 4 | 5 | 6 |
| Binder | n-BA:2-EHA: | | 50:49: | 50:49: | 60:39: | 60:39: | 50:49: | 50:49: | 50:49: | 50:49: | — |
| | 4-HBA | | 1 | 1 | 1 | 1 | 1 | 1 | 1 | 1 | |
| | Tg | | −59 | −59 | −59 | −59 | −59 | −59 | −66 | −66 | — |
| | Mw (×10⁴) | | 130 | 130 | 120 | 120 | 130 | 130 | 110 | 110 | — |
| | Content | | 100 | 100 | 100 | 100 | 100 | 100 | 100 | 100 | — |
| Oligomer | Kind | | 1 | 1 | 1 | 2 | 2 | — | 1 | 2 | — |
| | Mw (×10⁴) | | 3 | 3 | 3 | 4 | 4 | — | 3 | 4 | — |
| | Tg | | 31 | 31 | 31 | 90 | 90 | — | 31 | 90 | — |
| | Content | | 0.08 | 0.12 | 0.08 | 0.04 | 0.04 | — | 0.12 | 0.04 | — |
| Curing | Trifunctional | | 0.03 | 0.03 | 0.03 | 0.03 | 0.03 | 0.03 | — | — | — |
| agent | NCO based | | | | | | | | | | |
| | Bifunctional | | — | — | — | — | — | — | 0.03 | 0.03 | — |
| | NCO based | | | | | | | | | | |
| | Metal chelate | | 0.05 | 0.05 | 0.05 | 0.05 | 0.05 | 0.05 | 0.05 | 0.05 | — |
| | based | | | | | | | | | | |
| Silane coupling agent | | | 0.05 | 0.05 | 0.05 | 0.05 | 0.05 | 0.05 | 0.05 | 0.05 | — |
| Thickness | | | 15 | 15 | 15 | 15 | 15 | 15 | 15 | 15 | 15 |
| Thickness deviation of | | | 4 | 4 | 4 | 4 | 4 | 4 | 4 | 4 | 10 |
| adhesive film | | | | | | | | | | | |
| Peel | @glass | @25° C. | 800 | 880 | 780 | 730 | 750 | 300 | 300 | 460 | 410 |
| strength | plate | | | | | | | | | | |
| | @PET | @25° C. | 780 | 810 | 740 | 610 | 690 | 200 | 330 | 460 | 620 |
| Peel | @PET | @85° C. | 460 | 480 | 440 | 260 | 350 | 120 | 160 | 210 | 320 |
| strength | | | | | | | | | | | |
| Peel | @PI | @25° C. | 750 | 790 | 720 | 480 | 520 | 170 | 290 | 420 | 490 |
| strength | @PI | @85° C. | 450 | 480 | 430 | 220 | 310 | 90 | 110 | 240 | 230 |

| | | | | | | | | | | |
|---|---|---|---|---|---|---|---|---|---|---|
| Shear | @60° C. | 23.1 | 23.7 | 23.3 | 24.3 | 26.8 | 34.0 | 92.2 | 68.9 | 21.5 |
| strain | | | | | | | | | | |
| Storage | @−20° C. | 0.11 | 0.12 | 0.12 | 0.11 | 0.12 | 0.13 | 0.16 | 0.17 | 0.10 |
| modulus | @60° C. | 0.03 | 0.03 | 0.03 | 0.03 | 0.03 | 0.03 | 0.03 | 0.03 | 0.03 |

| | | | | | | | | | |
|---|---|---|---|---|---|---|---|---|---|
| tan δ MAX | −41 | −43 | −42 | 42 | −39 | −44 | −46 | −45 | −38 |
| Foldability at low | OK | OK | OK | OK | OK | OK | OK | OK | OK |
| temperature | | | | | | | | | |

*In Table 1
(Meth)acrylic based oligomer 1: Oligomer formed of 4-hydroxybutyl acrylate, methyl methacrylate, methacrylic acid and n-butyl acrylate (Saiden Co., Ltd.)
(Meth)acrylic based oligomer 2: Oligomer formed of 4-hydroxybutyl acrylate, methyl methacrylate, methacrylic acid and tert-butyl methacrylate (Saiden Co., Ltd.)
Trifunctional NCO-based curing agent: TDI (toluene diisocyanate)-TMP (trimethylol propane) modified adduct (Saiden Co., Ltd.)
Bifunctional NCO-based curing agent: HDI based, hexamethylene diisocyanate curing agent (NCI)

Metal chelate based curing agent: aluminum chelate curing agent (Saiden Co., Ltd.)

Silane coupling agent: 3-glycidoxy propyltrimethoxysilane (Saiden Co., Ltd.)

As shown in Table 1, the adhesive films according to the present invention had a thin thickness with a small thickness deviation, were formed of a heat curable composition, and exhibited good foldability. The adhesive films according to the present invention had high peel strength with respect to a polyimide based film. Accordingly, although not shown in Table 1, it is expected that the adhesive film according to the present invention can be adhered to the polyimide film of the foldable optical display apparatus with high reliability.

However, the adhesive film of Comparative Example 6, which was formed of a photocurable composition, had a large thickness deviation when formed into a thin structure. The adhesive films of Comparative Examples 1 to 5 failing to satisfy the features of the present invention had a peel strength of less than 600 gf/25 mm with respect to a polyimide based film. Accordingly, although not shown in Table 1, it is expected that the adhesive films of the Comparative Examples can be adhered to the polyimide based film of the foldable optical display apparatus with low reliability.

Although some embodiments of the present invention have been described herein, it is to be understood that various modifications, changes, alterations, and equivalent embodiments can be made by those skilled in the art without departing from the spirit and scope of the present invention.

What is claimed is:

1. An adhesive film comprising: a (meth)acrylic based copolymer, a (meth)acrylic based oligomer, and a curing agent,
the adhesive film having a maximum shear strain of 50% or less at 60° C. and a peel strength of 600 gf/25 mm or more with respect to a polyimide based film at 25° C.

2. The adhesive film according to claim 1, wherein the adhesive film has a peel strength of 400 gf/25 mm or more with respect to a polyimide based film at 85° C.

3. The adhesive film according to claim 1, wherein the adhesive film has a thickness deviation of 4 nm or less.

4. The adhesive film according to claim 1, wherein the adhesive film has a storage modulus of 0.2 MPa or less at −20° C.

5. The adhesive film according to claim 1, wherein the adhesive film has a storage modulus ratio (storage modulus at −20° C.:storage modulus at 60° C.) of 1:0.1 to 1:0.8.

6. The adhesive film according to claim 1, wherein the (meth)acrylic based copolymer is a copolymer of a monomer mixture comprising at least two alkyl group-containing (meth)acrylic based monomers having different homopolymer glass transition temperatures.

7. The adhesive film according to claim 6, wherein the alkyl group-containing (meth)acrylic based monomers have a homopolymer glass transition temperature of −50° C. or less.

8. The adhesive film according to claim 7, wherein the monomer mixture comprises a mixture of n-butyl acrylate and 2-ethylhexyl acrylate as the alkyl group-containing (meth)acrylic based monomers.

9. The adhesive film according to claim 1, wherein the (meth)acrylic based oligomer has a glass transition temperature of 50° C. or less.

10. The adhesive film according to claim 1, wherein the adhesive film is formed of a composition comprising the (meth)acrylic based copolymer, the (meth)acrylic based oligomer, and the curing agent.

11. The adhesive film according to claim 10, wherein the (meth)acrylic based oligomer is present in an amount of greater than 0 parts by weight to 5 parts by weight relative to 100 parts by weight of the (meth)acrylic based copolymer in the composition.

12. The adhesive film according to claim 10, wherein the curing agent comprises a tri- or higher functional isocyanate based curing agent.

13. The adhesive film according to claim 12, wherein the tri- or higher functional isocyanate based curing agent is present in an amount of greater than 0 parts by weight to 1 part by weight relative to 100 parts by weight of the (meth)acrylic based copolymer in the composition.

14. The adhesive film according to claim 10, wherein the composition further comprises a metal chelate based curing agent, the metal chelate based curing agent being present in an amount of 5 parts by weight or less relative to 100 parts by weight of the (meth)acrylic based copolymer in the composition.

15. The adhesive film according to claim 1, wherein the (meth)acrylic based oligomer comprises a hydroxyl group.

16. The adhesive film according to claim 1, wherein the (meth)acrylic based oligomer comprises a (meth)acrylic based monomer having a homopolymer glass transition temperature of 90° C. or more as a unit component.

17. The adhesive film according to claim 16, wherein the (meth)acrylic based monomer comprises at least one selected from among methyl methacrylate, methacrylic acid, and t-butyl methacrylate.

18. The adhesive film according to claim 1, further comprising a metal chelate based curing agent.

19. The adhesive film according to claim 1, wherein the adhesive film has a thickness of 20 μm or less.

20. An optical member comprising the adhesive film according to claim 1.

21. An optical display apparatus comprising the adhesive film according to claim 1.
